(19) United States
(12) Patent Application Publication
(10) Pub. No.: US 2017/0173882 A1
(43) Pub. Date: Jun. 22, 2017

(54) DEVICE AND METHOD FOR BUILDING A THREE-DIMENSIONAL STRUCTURE IN LAYERS

(71) Applicant: Airbus Operations GmbH, Hamburg (DE)

(72) Inventors: Hermann Benthien, Hamburg (DE); Andreas Poppe, Hamburg (DE)

(73) Assignee: Airbus Operations GmbH, Hamburg (DE)

(21) Appl. No.: 15/375,688

(22) Filed: Dec. 12, 2016

(30) Foreign Application Priority Data
Dec. 16, 2015 (DE) 10 2015 122 005.9

(51) Int. Cl. B29C 67/00; B33Y 30/00; B33Y 10/00

(52) U.S. Cl. CPC B29C 67/0085; B29C 67/0077; B33Y 10/00; B33Y 30/00

(57) ABSTRACT

A device for building a three-dimensional structure in layers includes at least one supply unit, at least one laser unit and one table, wherein the table comprises a circular surface and is adapted for rotating the circular surface around a central axis. The supply unit is adapted for applying a powdery material in layers on the circular surface of the table. The laser unit at the same time can partly or completely melt powdery material already applied by the supply unit while the circular surface is rotating.

### FIELD OF THE INVENTION

The present subject-matter relates to a device and a method for building a three-dimensional structure in layers, in particular to a device and method for three-dimensional printing with a powdery material, e.g. aluminum powder.

### BACKGROUND OF THE INVENTION

A buildup in layers of a three-dimensional structure typically starts with the construction of the structure wherein a three-dimensional model is generated computer assisted, for instance.

Preparatory works follow which comprise the generation of layer information by means of a frontend software, for instance. Subsequently, the actual production with a suitable method starts wherein the component or structure is manufactured in a suitable machine. Usually, the manufactured structure is finished afterwards.

Corresponding manufacturing methods may be differentiated in particular in terms of the material used for building the structure. So, on the one hand, in particular methods are known which utilize a liquid, e.g. a liquid monomer within the so called stereolithography. On the other hand, methods with solid matters are known which utilize wire (FLM-method) or powder (3D-print, SLS or SLM), for instance.

In stereolithography typically a fluid monomer is provided in a container with a lowerable platform. The structure is generated by hardening the surface of the liquid monomer by means of a laser to a thin layer and subsequently lowering the same by the thickness of the hardened layer in order to generate the next layer. This process is repeated until the structure is completely built.

In the so called Fused Layer Modeling (FLM) the layered buildup is carried out by melting a wire.

In three-dimensional printing, powder from a powder reservoir is applied on a table in layers, wherein a so called powder bed is formed. The application is typically carried out by means of a distributor for the powder, which is able to move along the table. A printing head can selectively apply a bonding active component (binder) in particular on the uppermost layer of the powder bed, whereby powder particles of the powder bed are bonded in certain areas. After desired areas of the powder bed are bonded in this manner, a further powder layer is applied and again as selective bonding of powder particles is carried out. This process is repeated until the structure is completed. By means of three-dimensional printing, in particular multicolored members can be manufactured, wherein the binder is usually the weakest link in the structure.

In the so-called selective laser sintering (SLS)/melting (SLM), the powdery particles are not bonded using a binder but partly melted (SLS) or completely melted (SLM) by means of a laser device. At the same time, the temperature is raised in a corresponding process chamber. Usually, the table is moved downward after the generation of one layer, in order to enable the application and partial melting or full melting of a new layer. These processes are repeated until the structure is completely built up.

The above described methods which use solid matter for the construction of the three-dimensional structure are in particular characterized by a high accuracy and middle to high strength values. Furthermore, they in particular allow prototype construction, manufacturing as well as tooling (SLM). However, the application of the powder layers and the partial melting or full melting can take up a lot of manufacturing time in the generation of the structure. In particular when using powder for the buildup in layers a sequential application of the powder and subsequent lasering is always necessary.

### BRIEF SUMMARY OF THE INVENTION

Accordingly, there may be a need to provide a device and a method in a manner as described at the outset, which allow for a reduction of the construction time and the manufacturing costs.

According to an embodiment, the device for building a three-dimensional structure in layers comprises at least one supply unit, at least one laser unit and a table. The table comprises a circular surface and is adapted to rotate the circular surface about central axis. The supply unit is adapted to cover the circular surface of the table with a powdery material in layers wherein the covering is preferably carried out continuously. The laser unit is able to simultaneously, that is to say while the supply unit is applying powdery material on the circular surface in layers, partly or completely melt the powdery material which was already applied by the supply unit. The application of powdery material and the partial or full melting of powdery material can thereby be simultaneously carried out, namely while the circular surface is rotating.

The supply unit is preferably connected to a reservoir of the powdery material and adapted to supply the powdery material preferably from the reservoir onto the table layer by layer. In particular, the supply unit can be arranged above the table and can be adapted to cover the supply area, in particular having the shape of a sector, of the circular surface of the table with multiple layers of the powdery material. The powdery material can in particular be aluminum powder.

The circular surface can be rotated continuously as well as intermittently. The rotatable table thereby makes it possible that the supply area—also with stationary supply unit—can shift along the circular surface in circumferential direction of the same and that a layer of powdery material can thus be applied on the entire circular surface of the table. Structures to be built up can in principle be arranged on the entire rotating surface of the table.

The supply area is thus—even with stationary supply unit—not stationary but moves along the circular surface of the table and a powder bed, respectively, which powder bed can comprise one or more layers of powdery material dependent on how far the building up of the structure already proceeded. Hence, in the shifting supply area a layer can be completed or a new layer of powdery material can be applied. Outside of the supply area a previously applied powder layer can simultaneously be partly melted or completely melted by the laser unit, in order to generate a layer of the structure to be built up, wherein in the shifting supply area a new powder layer is already simultaneously applied. The supply unit and the table can thereby be controlled in particular by a control unit which can in particular be adapted to coordinate the rotation of the table or its circular surface, an output amount and/or an output unit of the supply unit, as well as a light intensity of the laser unit in a suitable manner.

The device according to an embodiment of the present subject-matter in particular allows that the powdery material can be further continuously applied during the partial or full melting by means of the laser unit. It is no longer necessary to wait with the application of a new powder layer until the partial or full melting is finished. In this way, it can also be prevented that the partial or full melting has to be interrupted for the application of a new powder layer. All in all, the device according to the present subject-matter contributes to the ability to be able to manufacture a structure to be built particularly efficient, whereby in particular manufacturing time and costs can be reduced.

According to an embodiment, it is provided that the at least one supply unit is adapted to apply a layer of the powdery material in a sector shaped supply area of the circular surface. In this way, it can be particularly easily rendered possible that the rotating circular surface can be completely covered with powdery material.

Particularly advantageous it can further be provided that the device comprises multiple supply units which are respectively adapted to apply a layer of the powdery material in multiple sector shaped supply areas spaced apart from each other in circumferential direction of the circular surface of the table. In this way, it is made possible that in different areas of the rotating circular surface a respective new layer of powdery material can be applied which can subsequently be partly or completely melted between two adjacent sector shaped supply areas by means of at least one laser unit. It is therefore particularly advantageously provided that at least one laser unit is respectively adapted to partly or completely melt a previously applied layer of powdery materials between two sector shaped supply areas which are adjacent to each other in the circumferential direction.

According to a further embodiment it is provided that the device comprises a detection unit which is adapted to determine whether an intended partial melting or full melting by means of the at least one laser unit has been carried out or not. By way of example the detecting unit can comprise a suitable sensor which are, for instance, is adapted to detect pores within the powder layer. The detection unit allows for an examination of the intended partial or full melting and thus an examination whether one layer of the structure to be built up has been built up as desired or not. The detection unit can be adapted to transmit corresponding data to the control unit for evaluation and corresponding control of the supply units, laser units and the table.

In this connection, it is in particular advantageously provided that two laser units are adapted to partly or completely melt a layer of powdery materials between two sector shaped supply areas which are spaced from each other in circumferential direction. In particular, when the detection unit determines that an area has not been partly or completely melted as intended by means of an in direction of rotation leading laser unit the partial or full melting which was not carried out or not carried out as desired can be subsequently carried out by means of an in direction of rotation following laser unit.

Furthermore, it can be advantageously provided that the circular surface is lowerable along its central axis. In this way, a first layer can, as described above, be applied by means of the supply unit, partly or completely melted by means of the laser unit and subsequently lowered by its layer height, so that a second layer can, as described above, be applied on the first layer by means of the supply unit and partly or completely melted by means of the laser unit.

The method for building a three-dimensional structure in layers according to an aspect of the present subject-matter starts with a provision of an above-described device according to the present subject-matter. Furthermore, an application of a layer of the powdery material by means of the at least one supply unit in a supply area of the circular surface of the table and a rotation of the applied layer into an operating area of the at least one laser unit by rotating the circular surface about its central axis are carried out so that the previously applied layer of powdery material is partly or completely melted by means of the laser unit wherein powdery material is further applied by the supply unit simultaneously.

Regarding effects, advantages and embodiments it is referred to the statements given above in connection with the device according to the present subject-matter.

### BRIEF DESCRIPTION OF THE DRAWINGS

In the following embodiments of the present subject-matter are described in greater detail with reference to the schematic drawing. Here:

FIG. 1 shows a side view of a device for building a structure in layers comprising a table, a supply unit with powdery material, and a laser unit,

FIG. 2 shows a plan view of a circular surface of the table according to FIG. 1 without a depiction of powdery material, and

FIG. 3 shows a plan view on a circular surface of a table of a further device for building a structure in layers without a depiction of powdery material.

### DETAILED DESCRIPTION

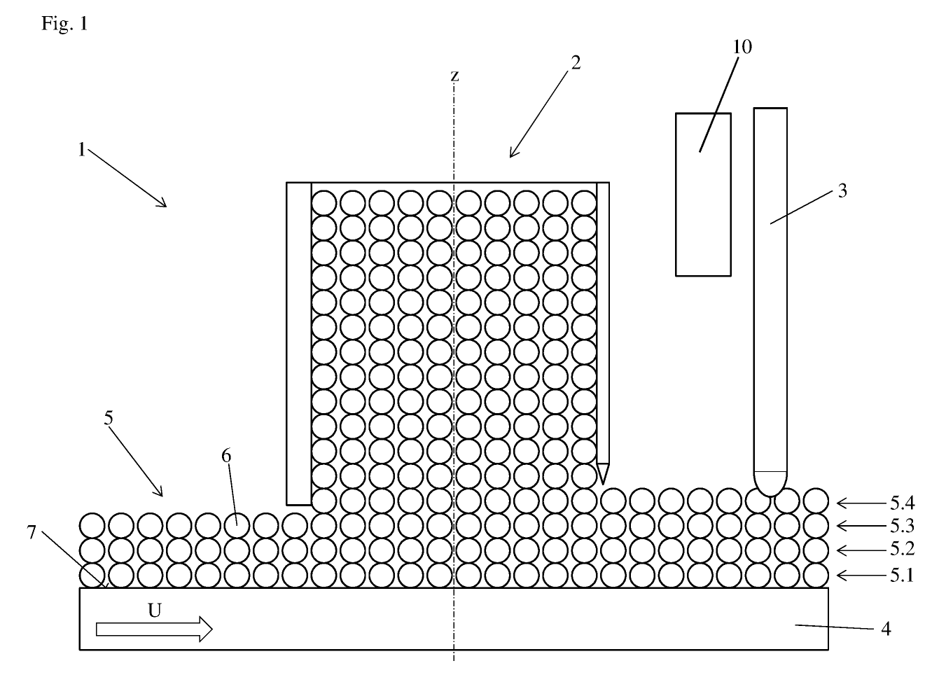

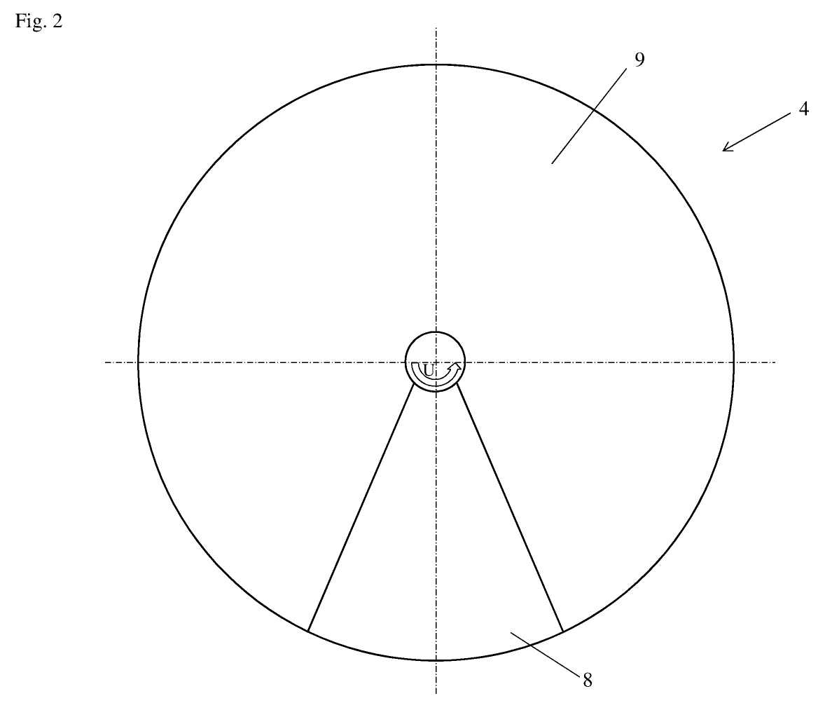

FIGS. 1 and 2 show a device 1 for building a structure in layers. The device 1 comprises a supply unit 2, a laser unit 3 and a table 4. A powder bed 5 which comprises multiple layers 5.1 to 5.4 can be applied on the table 4 by means of the supply unit 2. The number of layers 5.1 to 5.4 is in particular dependent on the thickness of the layers 5.1 to 5.4 as well as on the dimensions of the structure to be built up. The table 4 comprises a circular surface 7 which can be automatically rotated in circumferential direction U about its central axis z by means of a not shown drive system. The supply unit 2 comprises and opening facing the circular surface 7 wherein powdery material 6 can be supplied from the supply unit 2 and applied in layers on the circular surface 7 of the table 4 in a sector shaped supply area 8 via the opening.

The laser unit 3 is arranged behind the supply unit 2 in rotational direction U so that first a layer 5.1 to 5.4 can be applied and then partly or completely melted by the following laser unit 3. In the embodiment as shown in FIGS. 1 and 2 the supply unit 2 applies a fourth layer 5.4 of powdery material 6 on the circular surface 7 of the table 4 in the sector shaped supply portion 8. The fourth layer 5.4 as applied in the sector shaped supply portion 8 is rotated together with the circular surface 7 in circumferential direction U and is partly or completely melted in a melting section 9 by means of the laser unit 3 while the leading supply unit 2 further applies the fourth layer 5.4 continuously on the circular surface 7. As soon as the fourth layer 5.4 is completely applied and partly or completely melted in designated areas the circular surface 7 of the table 4 is lowered by the height of a layer 5.1 to 5.4 so that upon further rotation of the circular surface 7 a further layer of powdery material 6 can be applied and partly or completely melted. The described application, partial or full melting and lowering is repeated until all necessary layers for building the structure have been generated.

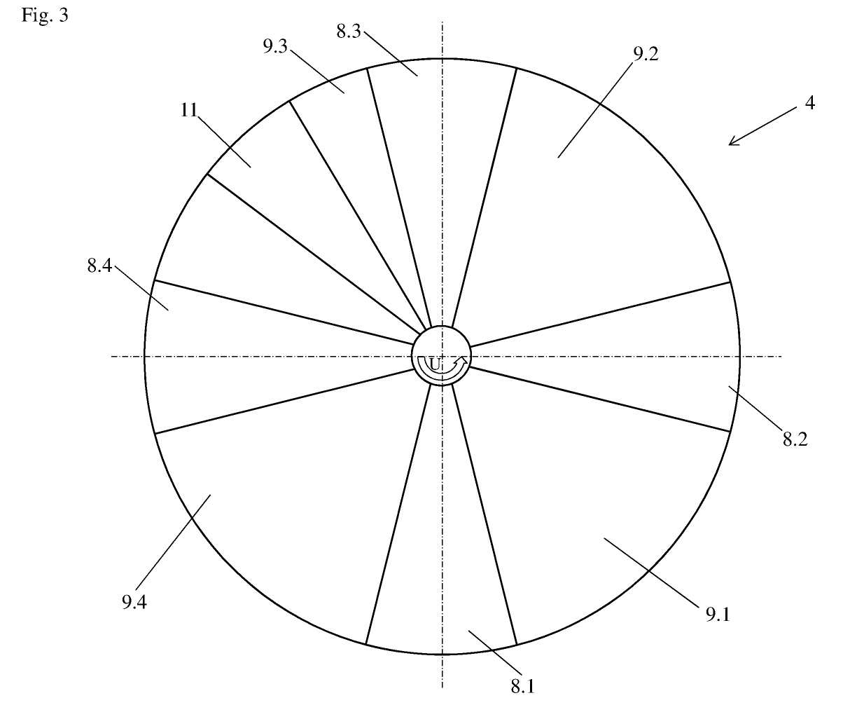

FIG. 3 differs from FIG. 1 in that instead of one sector shaped supply area 8 four equidistantly spaced supply areas 8.1 to 8.4 are provided. This is achieved by arranging four supply units 2 according to FIG. 1 with same distance to each other above the circular surface 7 of the table 4. Between two supply units 2 which are adjacent to each other in circumferential direction U, at least one laser unit 3 is respectively arranged in one of four melting areas 9.1 to 9.4 which are also spaced from each other in circumferential direction U. A detecting unit 10 as shown in FIG. 1 can, for example, detect in a detection area 11 whether a laser unit 3 as arranged in the melting area 9.3 has partly or completely been melted as desired in an area of an applied layer. If this is the case, for example, a laser unit which is also arranged in the melting area 9.3 and which is arranged such that it follows in circumferential direction U does not have to partly or completely melt the layer before powdery material 6 is applied in the supply area 8.4 again. If the detector unit 10 determines that the laser unit 3 arranged in the melting area 9.3 did not partly or completely melt an area of an applied layer at all or not as desired, the following laser unit can for example partly or completely melt the layer as previously applied by the supply unit in the related area as desired before powdery material 6 is again applied in the supply area 8.4. Such a laser unit which follows in circumferential direction U consequently serves as a correction laser unit.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A device for building a three-dimensional structure in layers, the device comprising:
at least one supply unit;
at least one laser unit; and
a table,
wherein the table comprises a circular surface and is adapted to rotate the circular surface around a central axis,
wherein the supply unit is adapted to cover the circular surface of the table with a powdery material in layers, and
wherein the laser unit can at the same time partly or completely melt powdery material applied by the supply unit while the circular surface is rotating.

2. The device according to claim 1, wherein the at least one supply unit is adapted to apply a layer of the powdery material in a sector shaped supply area of the circular surface.

3. The device according to claim 1, wherein the device comprises multiple supply units adapted to apply a layer of the powdery material in multiple sector shaped supply areas of the circular surface, and
wherein the sector shaped supply areas are spaced from each other in circumferential direction of the circular surface of the table.

4. The device according to claim 3, wherein respectively at least one laser unit is adapted to partly or completely melt a previously applied layer of powdery material between two sector shaped supply areas adjacent to each other in circumferential direction.

5. The device according to claim 3, further comprising a detecting unit adapted to detect whether a desired partly or completely melting has been carried out or not by the at least one laser unit.

6. The device according to claim 3, wherein two laser units are adapted to partly or completely melt one layer of powdery material between two sector shaped supply areas spaced from each other in circumferential direction.

7. The device according to claim 1, wherein the circular surface is lowerable along the central axis.

8. A method for building a three-dimensional structure in layers, the method comprising:
providing a device comprising at least one supply unit, at least one laser unit and table, wherein the table comprises a circular surface and is adapted to rotate the circular surface around a central axis, wherein the supply unit is adapted to cover the circular surface of the table with a powdery material in layers and wherein the laser unit can at the same time partly or completely melt powdery material applied by the supply unit while the circular surface is rotating;
applying a layer of the powdery material in a supply area on the circular surface of the table by means of the at least one supply unit; and
rotating the applied layer into an operating area of the at least one laser unit by rotating the circular surface about the central axis so that the previously applied layer of the powdery material is partly or completely melted by means of the laser unit, wherein at the same time powdery material is further applied by means of the at least one supply unit.
